(19) United States
(12) Patent Application Publication
(10) Pub. No.: US 2022/0331201 A1
(43) Pub. Date: Oct. 20, 2022

(54) Combined Lung Mobilizer and Ventilator

(71) Applicant: John Hincks Duke, Providence, RI (US)

(72) Inventor: John Hincks Duke, Providence, RI (US)

(21) Appl. No.: 17/233,383

(22) Filed: Apr. 16, 2021

(51) Int. Cl. A61H 31/00

(52) U.S. Cl. CPC A61H 31/008; A61H 2203/0468; A61H 2201/0146; A61H 2201/0192; A61H 2201/12

(57) ABSTRACT

An articulated patient support platform cyclically expands and contracts a patient's lung volume, to both support breathing and mobilize lung tissue. In the lung expansion phase, a change in angle between a leg and hip supporting portion and a chest and head supporting portion causes extension the patient's spine, which increases the distance between the patient's sternum and spine. In the lung contraction phase, the reverse change in this angle causes flexion the patient's spine, which decreases the distance between the sternum and spine. A cycle of increase and decrease in spine-sternum distance expands and contracts lung volume in the manor of a bellows. Motorized operation of the platform thereby provides non-invasive natural breathing support. A corollary benefit of this lung expansion/contraction cycle is mobilization of lung tissue, which is beneficial in reducing post-operative pneumonia risk.

### PRIORITY CLAIM

This application claims priority to U.S. Provisional Patent Application No. 63/011,288 entitled “SPINAL FLEXION PULMONARY VENTILATOR” filed on Apr. 16, 2020, U.S. Provisional Patent Application No. 63/018,497 entitled “COMBINED SPINAL FLEXION LUNG MOBILIZER-VENTILATOR” filed on Apr. 30, 2020, U.S. Provisional Patent Application No. 63/021,671 entitled “COMBINED SPINAL FLEXION LUNG MOBILIZER-VENTILATOR” filed on May 7, 2020, and U.S. Provisional Patent Application No. 63/026,132 entitled “COMBINED LUNG MOBILIZER AND VENTILATOR” filed on May 17, 2020.

### BACKGROUND OF THE INVENTION

Pneumonia is the third most common postoperative complication. In the Nationwide Inpatient Sample, the overall surgical incidence was 0.97%, and 3.3% for cardiothoracic surgeries. In the American College of Surgeons National Surgical Quality Improvement Program, overall incidence was 1.3%, and 5.3% for cardiothoracic surgeries. A first objective of the present invention is to provide a non-invasive and efficiently administered intervention to lessen the risk of postoperative pneumonia. A second objective is to provide the same benefit in managing the progression of infectious diseases known to present pneumonia in acute stages, such as Sars-CoV-2.

Pneumonia risk from surgical procedures is a consequence of long periods under general anesthetics. Anesthetic agents can alter the elastic recoil pressure of the chest wall relative to the lung wall, which may reduce lung volume and compliance. This increases risk of atelectasis. Anesthetics also alter the lung's ability to mobilize and eliminate secretions by reduced surfactant production, leaving mucus plugs in alveolar cavities, which directly increases pneumonia risk.

Given the above known pathophysiology of postoperative pneumonia, present medical practice to reduce that risk comprises these interventions: (1) deep breathing exercises and incentive spirometry, (2) coughing, (3) frequent repositioning to mobilize secretions, (4) early mobilization and ambulation, and (5) optimal pain management. Four out of five of these interventions share a common goal of lung tissue mobilization though lung expansion and whole body movement. The challenge inherent in providing this care is dependence upon either patient self-motivation in their weakened postoperative state or one-on-one attention of nursing professionals or pulmonary specialists. The present invention addresses this challenge by providing a powered but non-invasive means to mobilize the lungs.

The invention is a dynamic multi-plane platform on which a patient lies in a prone position. A mechanically powered angular motion between a leg and hip supporting portion and a chest and head supporting portion results in a cycle of spinal extension and flexion which respectively expands and contracts the lungs without patient effort. Spinal extension, wherein the prone patient's upper back arcs upward, causes lung expansion and inspiration firstly because the lower ribs tilt away from the spine, and secondly because the entire lung volume stretches and is pulled away from the abdominal viscera, which is equivalent to a diaphragm contraction that enlarges the thoracic cavity. The opposite spinal flexion, wherein the prone patient's upper back arcs downward, does the reverse, which forces expiration in the manner of a bellows. Both phases of this cycle actively mobilize lung wall tissue on a micro scale, which is functionally equivalent to the above deep breathing exercises prescribed for pneumonia prevention. The device may be tuned to operate at various cycle frequencies and angular amplitudes without continuous one-on-one professional attention.

In addition to the benefit of lung tissue mobilization for secretion elimination, the powered cycle of lung expansion and contraction also provides a non-invasive ventilation function that may forestall progression to intubation in acute cases of respiratory distress.

In the preferred embodiment of the invention, low elevation platform support structure enables placement of the entire device on top of the mattress of a conventional hospital bed. In this form, the invention does not require dedicated treatment space. This avoids a need to transport the patient.

In the prior art, mechanical devices that aid airway clearance include wearable percussion vests with high frequency vibration engines, such as disclosed by Shockley, Jr. et al. in U.S. Pat. No. 10,610,446 and Van Brunt et al. in U.S. Pat. No. 6,471,663. Such wearable devices do not provide the deep ventilation function of the present invention.

The prior art of non-invasive whole body mechanical ventilators includes negative pressure devices such as the “iron lung” used to treat poliomyelitis. A later innovation was the rocking bed device, such as the “Respir-aid Rocking Bed” manufactured by the McKesson Appliance Company of Toledo, Ohio. Such rocking beds tip a supine patient up to 30 degrees back and forth in a sagittal plane, for a total angular displacement of up to 60 degrees. This motion causes gravity induced viscera and diaphragm movement that yields breath tidal volume sufficient to support breathing.

### BRIEF DESCRIPTION OF THE DRAWINGS

FIG. 1 is a rear quarter perspective view.

FIG. 2 is a forward quarter perspective view.

FIG. 3 is a side plan view in the spine flexed downward position.

FIG. 4 is a side plan view in the spine extended upward position.

FIG. 5 a side plan view with platforms in the level and parallel position.

FIG. 6 is rear quarter perspective view of an alternative embodiment with a non-sliding leg and hip support platform.

FIG. 7 is side plan view of the alternative embodiment of FIG. 6.

### DETAILED DESCRIPTION OF THE INVENTION

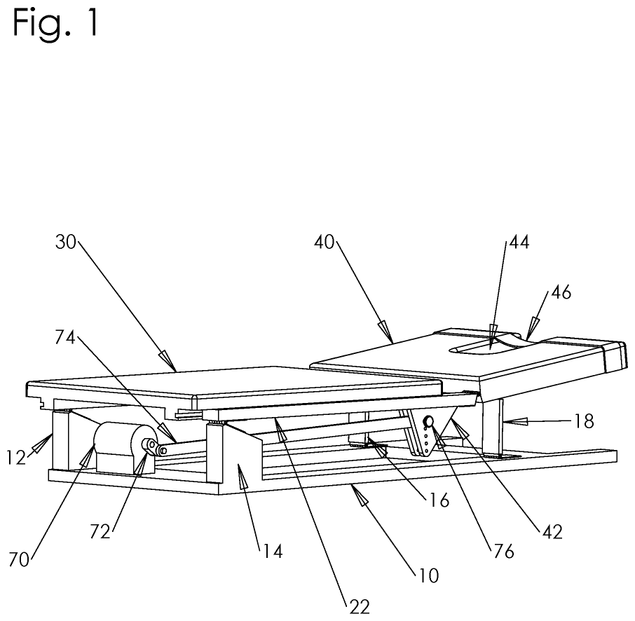

FIG. 1 shows a substantially flat base 10 with a forward end, a rear end, a left side, and a right side. In the preferred embodiment base 10 is supported when in clinical use on top of a hospital bed not shown, or in other embodiments may be fitted with a floor support frame. A rear left fixed support post 12 projects upward from the rear left portion of base 10. A rear right fixed support post 14 projects upward from the rear right portion of base 10. A forward left pivoting support post 16 pivotably connects to the forward left portion of base 10 about a substantially transverse axis. A forward right pivoting support post 18 pivotably connects to the forward right portion of base 10 about an axis substantially coaxial with the axis of pivoting support post 16. The upper ends of pivoting support posts 16 and 18 pivotably connect about a substantially common transverse axis to the underside of a chest and head support platform 40. The upper end of fixed support post 12 pivotably connects about a substantially transverse axis to the underside of a rear left rail 20 not shown. The upper end of fixed support post 14 pivotably connects about a substantially transverse axis to the underside of a rear right rail 22. The respective pivot axes of fixed support posts 12 and 14 to rails 20 and 22 are substantially coaxial. The forward ends of rails 20 and 22 pivotably connect respectively about a substantially common transverse axis to a rear left and rear right portion of chest and head support platform 40. Rails 20 and 22 slideably support a leg and hip support platform 30. The forward middle portion of chest and head support platform 40 has a head cutout 44. An adjustable transverse head support strap 46 spans head cutout 44.

FIG. 1 further shows a motor 70 with a power cable not shown and a user control interface not shown fixed to the rear upper surface of base 10. Motor 70 turns a first end of a crank 72 about a substantially transverse axis. A second end of crank 72 pivotably connects to a rear end of a strut 74 about a substantially transverse axis. A forward end of strut 74 pivotably connects to a moment arm 42 that projects downward from the underside of chest and head support platform 40. The location of the pivot connection between strut 74 and moment arm 42 is operator adjustable at various radial distances from the pivot axis between chest and head support platform 40 and pivoting support posts 16 and 18. In the preferred embodiment, the means of strut 74 pivot location adjustment is movement of a pin 76 to one of a linear array of holes in moment arm 42, and coincident movement of the forward end of strut 74 to that hole location.

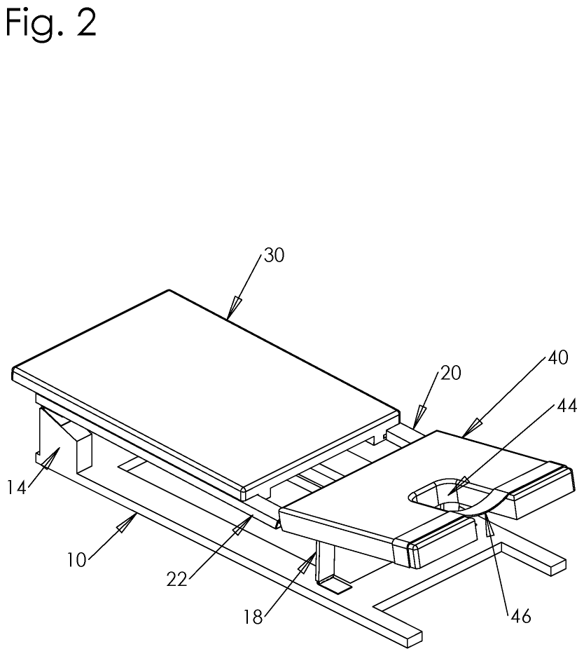

FIG. 2 is a frontal elevated perspective view of the invention further showing rear left rail 20.

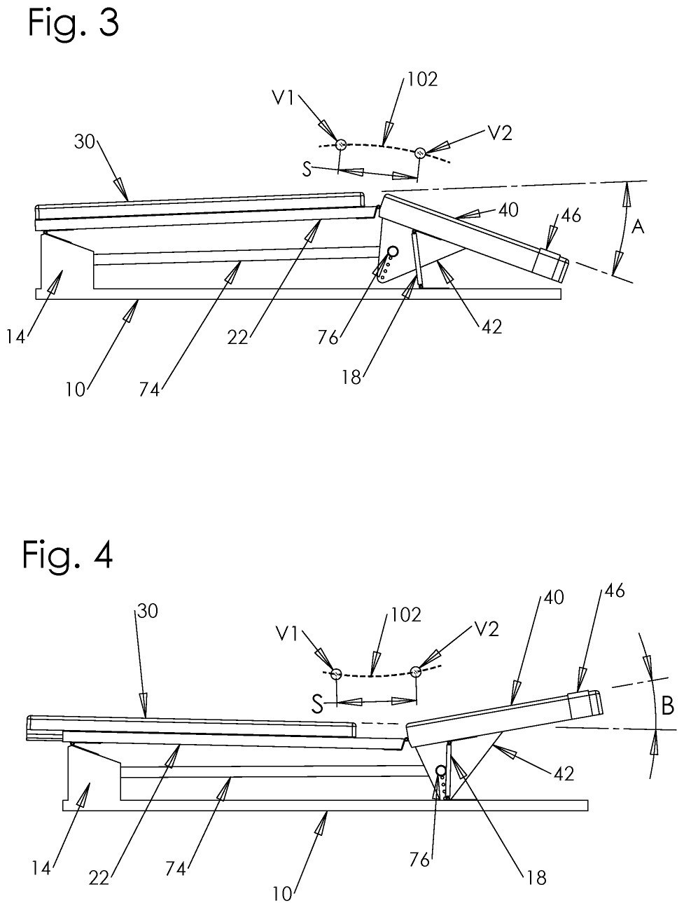

FIG. 3 is a side elevation view showing chest and head support platform 40 at a maximum downward operating angle A with respect to leg and hip support platform 30. In the preferred embodiment angle A is approximately 20 degrees. The strut 74 pivot location on moment arm 42 shown in FIG. 3 is at a minimum distance from the axis between chest and head support platform 40 and pivoting support posts 16 and 18. Leg and hip support platform 30 in FIG. 3 is at its farthest forward slide position on rails 20 and 22.

FIG. 3 further shows a point in space V1 at the approximate offset of a patient's spine normal to leg and hip support platform 30 and a fixed position with respect to the forward end of leg and hip support platform 30. A point in space V2 is at the approximate offset of a patient's spine normal to chest and head support platform 40 and a fixed position with respect to the rear end of chest and head support platform 40. A dimension S is the distance between points V1 and V2. A dashed line 102 indicates the plan view profile of a patient's spine coincident with points V1 and V2.

FIG. 4 is a side elevation view showing chest and head support platform 40 at a maximum upward operating angle B with respect to leg and hip support platform 30. In the preferred embodiment angle B is approximately 12 degrees. The strut 74 pivot location on moment arm 42 shown in FIG. 4 is as in FIG. 3. Points V1 and V2, dimension S, and line 102 are as in FIG. 3. Because chest and head support platform 40 is angled up, points V1 and V2 are shifted rearward with respect to base 10, and the patient's lower body contact displaces leg and hip support platform 30 to its farthest rearward slide position on rails 20 and 22.

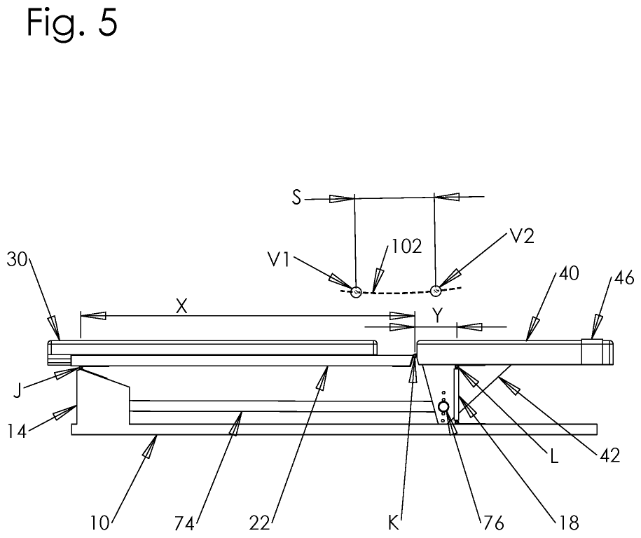

FIG. 5 is a side elevation view showing both leg and hip support platform 30 and chest and head support platform 40 substantially parallel to base 10. The transverse projection of an axis J is the common pivot axis between post 12 and rail 20 and between post 14 and rail 22. The transverse projection of an axis K is the common pivot axis between rails 20 and 22 and chest and head support platform 40. The transverse projection of an axis L is the common pivot axis between chest and head support platform 40 and the upper ends of forward left pivoting support post 16 and forward right pivoting support post 18. A dimension X is the longitudinal distance between axes J and K. A dimension Y is the longitudinal distance between axes K and L. In the preferred embodiment dimension X is 48 inches and dimension Y is 6 inches.

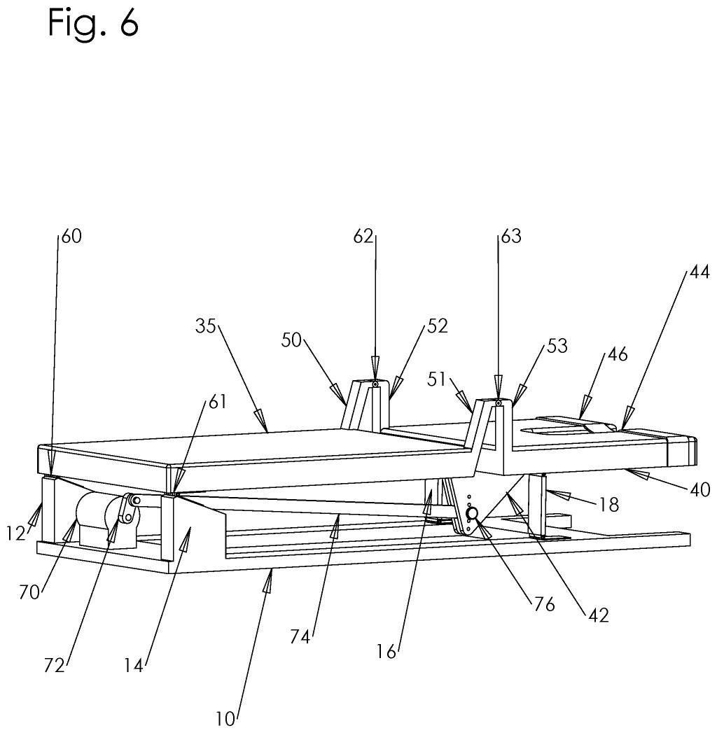

FIG. 6 is a rear quarter perspective view of an alternative embodiment of the invention. Leg and hip support platform 30 is replaced by a non-sliding leg and hip support platform 35. The rear end of non-sliding leg and hip support platform 35 pivotably connects to support posts 12 and 14 respectively at a pair of hinges 60 and 61. A rear left strut 50 and a rear right strut 51 project upwards from the left and right forward corners of leg and hip support platform 35. A forward left strut 52 and a forward right strut 53 project upwards from the left and right rear corners of chest and head support platform 40. Strut 50 pivotably connects to strut 52 at a hinge 62. Strut 51 pivotably connects to strut 53 at a hinge 63.

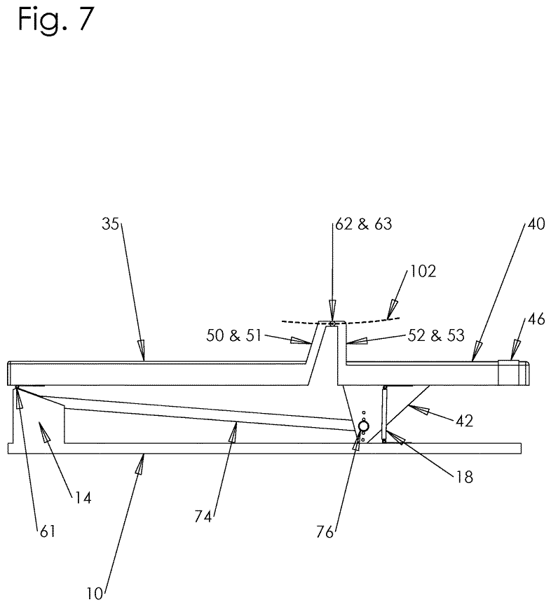

FIG. 7 is a side plan view of the alternative embodiment of FIG. 6 showing that the upward extent of struts 50, 51, 52, and 53 is such that the pivot axes of hinges 62 and 63 are coincident with the dashed line 102 indicating the plan view profile of a patient's spine.

### Mode of Operation of the Invention

In operation, an operator first adjusts the position of head support strap 46 for the size of the patient. A patient then lies prone on leg and hip support platform 30 and chest and head support platform 40, with axis K below a point approximately midway between her or his hips and rib cage. The relation between dimensions X and Y with respect to axis K is such that a patient's respective lower and upper body weights develop approximately equal and opposite opposing torques about axis L, so a patient's relaxed body at rest is substantially in balance in the level position of FIG. 5. Rotation of motor 70 then makes chest and head support platform 40 angle up and down with respect to leg and hip support platform 30 in a cycle between their respective FIG. 3 and FIG. 4 positions. Operator adjustment of the pin 76 position varies the amplitude of this cycle. The upward phase from the FIG. 3 position to the FIG. 4 position causes the patient's spine to extend upwards, which expands his or her lungs to both mobilize lung tissue and power inhalation. The downward phase from the FIG. 4 position to the FIG. 3 position causes the patient's spine to flex downwards, which contracts her or his lungs to both mobilize lung tissue and power exhalation. The above combination of non-invasive powered pulmonary ventilation with powered lung tissue mobilization is therapeutically beneficial.

In one mode of operation the rear end of base 10 is elevated. This may be appropriate while a patient is capable of exertion and able to tolerate a lower head position. If deployed upon a motorized hospital bed, the mattress foot elevation feature may provide this function. In this mode of operation, the motor 70 user control periodically pauses motor 70 in the downward angle A position of FIG. 3. This pause interval provides patient opportunity for gravity aided expectoration of fluids contained in her or his lungs. In addition to the benefit of pulmonary fluid elimination, the expectoration cough reflex similarly provides therapeutically beneficial lung mobility.

In operation, because the patient's spine is substantially constant in length and located in the posterior abdomen, as the spine flexes the anterior abdomen containing lung tissue must expand and contract. Gravitational contact by the anterior abdomen on leg and hip platform 30 and chest and head platform 40 therefore accordingly causes the distance between platforms 30 and 40 to expand and contract by slide action of platform 30 upon rails 20 and 22. In the alternative embodiment of FIGS. 6 and 7, an equivalent change in the distance between platforms 30 and 40 results from the arc swung by struts 50, 51, 52, and 53 about hinges 62 and 63.

What is claimed is:

1. A patient support platform that varies an angle between a first leg and hip supporting portion and a second chest and head supporting portion.

2. The platform of claim 1 in which the angle variation is cyclical.

3. The platform of claim 2 in which the cyclical angle variation is motorized.

4. The platform of claim 3 in which the frequency and amplitude of the cycle of angle variation is user adjustable.

5. The platform of claim 1 that further varies a distance between said first and second platform portions.

6. The platform of claim 5 in which the angle and distance variations are cyclical.

7. The platform of claim 6 in which the cyclical angle and distance variations are motorized.

8. The platform of claim 7 in which the frequency and amplitude of the cycle of angle and distance variations are user adjustable.

9. A method of therapeutic lung mobilization and ventilation comprising the steps of
placing the patient in a prone position and
applying mechanical energy to cyclically extend the patient's spine upwards and flex the patient's spine downwards.
